(19) United States
(12) Patent Application Publication
(10) Pub. No.: US 2022/0388690 A1
(43) Pub. Date: Dec. 8, 2022

(54) DEVICE AND METHOD FOR MANAGING A FLEET OF INFORMATION-COMMUNICATING DEVICES FOR UPDATING A DIGITAL TWIN OF A TURBOMACHINE

(71) Applicant: SAFRAN AIRCRAFT ENGINES, Paris (FR)

(72) Inventors: Alméric Pierre Louis GARNIER, Moissy-Cramayel (FR); Jacques AURIOL, Moissy-Cramayel (FR); Josselin Xavier COUPARD, Moissy-Cramayel (FR)

(73) Assignee: SAFRAN AIRCRAFT ENGINES, Paris (FR)

(21) Appl. No.: 17/755,988

(22) PCT Filed: Nov. 2, 2020
(86) PCT No.: PCT/FR2020/051972

§ 371 Date: May 13, 2022

(30) Foreign Application Priority Data
Nov. 14, 2019 (FR) FR1912734

(51) Int. Cl. B64F 5/60; B64F 5/40; B64D 45/00

(52) U.S. Cl. CPC B64F 5/60; B64F 5/40; B64D 45/00; B64D 2045/0085

(57) ABSTRACT

The disclosure relates to a device and a method for managing a fleet of information communication devices with reversible attachment on aircraft turbomachines, having: an association of a device among the fleet of devices with a turbomachine among a fleet of turbomachines, an attachment, an acquisition of at least one turbomachine operating parameter, a development of at least one indicator that allows the update of a digital twin of the turbomachine based on the operating parameter acquired, a communication of the indicator that allows the update of the digital twin to a digital twin storage entity.

### TECHNICAL FIELD

The present invention belongs to the field of aircraft maintenance assistance, particularly for the management of a fleet of turbomachines. It relates more particularly to a method and a device for communicating information relating to the operation of the turbomachines.

### PRIOR ART

Within the framework of the management of a fleet of turbomachines, digital twins of these turbomachines are generally used to digitally illustrate, describe, reproduce and simulate each turbomachine of the fleet. A digital twin is therefore an information representation of the turbomachine that allows in particular implementing simulations. By way of indication, a digital twin allows simulating the thermormechanical behavior of a turbomachine or the wear observed, and this in a digital environment.

Typically, a digital twin comprises, on a computer storage medium, configuration information, intervention and maintenance data, operational data, a three-dimensional digital mockup of the turbomachine, documentation, or digital models that allow digitally reproducing or simulating the operation of the associated turbomachine.

A fleet of turbomachines can be managed on the basis of a set of digital twins, particularly to implement maintenance operations if necessary. For example, digital twins can be used to monitor the health of turbomachines to implement predictive maintenance operations.

There are digital twins for equipment of the turbomachine, therefore, a turbomachine can be associated with a plurality of digital twins which can each refer either to a portion of the turbomachine or to the entire turbomachine. In the present application, the expression “digital twin of the turbomachine” refers at the same time to the digital twins for equipment of a turbomachine or to the digital twins for an entire turbomachine.

It has been observed that the digital twins of the turbomachines can contain information that poorly illustrates the actual state of a turbomachine. This results from the difficulty in acquiring information derived from the turbomachines.

The invention aims in particular to overcome these drawbacks.

### DISCLOSURE OF THE INVENTION

To this end, the invention proposes a method for managing a fleet of information communication devices with reversible attachment on aircraft turbomachines, comprising:

an association of at least one device among said fleet of devices with a turbomachine among a fleet of turbomachines,

an attachment of the device among said fleet of devices to the turbomachine among said fleet of turbomachines,

an acquisition of at least one turbomachine operating parameter,

a development of at least one indicator that allows the update of a digital twin of the turbomachine based on the operating parameter acquired,

a communication of said indicator that allows the update of the digital twin to a digital twin storage entity.

The method can further comprise updating the digital twin, possibly by the digital twin storage entity.

it is meant by reversible attachment an attachment of the device on the turbomachine which may be manual or does not require any tool.

The device can thus be quickly and easily mounted on and dismounted from the turbomachine without tools. The modular system can thus be successively mounted on different turbomachines as required. This removability allows extracting the data (the operating parameter) from the turbomachine very quickly, simply by withdrawing the modular device, which can be replaced by another device if necessary for the next flight. The data can then be recovered by connecting the thus withdrawn modular device to a ground station in the communication step.

This removability further allows limiting the mass impact on a turbomachine, and by extension on an aircraft, related to embedding such a device on the turbomachine.

It can be noted that the device used by the method is in fact of the modular type, the modularity of the device embedded as a Plug & Play kit allows it to be mounted on an ad hoc basis on at least one turbomachine and thus to avoid having two systems embedded on the same aircraft and to embed the system only when data recovery is necessary (i.e. acquiring the operating parameter).

Typically, the reversible attachment allows an operator to easily remove, for example in 30 minutes, the device and thus clearly optimize the operating time on the turbomachine.

Also, the invention allows easily recovering information for the update of a digital twin, since it suffices to implement the association and the attachment to authorize the recovery of necessary information. As a result, it is easy and quick to update a digital twin and the obsolescence of the digital twins is avoided.

For example, the operating parameter can be any value that a sensor of the device can measure.

It can be noted by way of indication that the steps of the method described above are implemented by the device. If an update of the digital twin is carried out, then this step is rather performed by the storage entity.

According to one particular mode of implementation, the method comprises a preliminary step of determining the out-of-date state of at least one portion of the digital twin of the turbomachine requiring said indicator that allows the update of the digital twin of the turbomachine based on the operating parameter acquired.

In this step, it will be possible in particular to determine among all the digital twins which ones are up to date and which ones are out of date, then to identify the turbomachines associated with the out-of-date twins.

This particular mode of implementation allows implementing the association and the attachment only for turbomachines having a digital twin which is not up to date. As a result, the impact on the mass related to the addition of the devices on the turbomachines is limited.

According to one particular mode of implementation, the out-of-date state of said at least one portion of the digital twin of the turbomachine is related to the detection of an event chosen from the group comprising: a duration since the last update of the portion exceeding a duration threshold, a discrepancy between information of said portion and information coming from the turbomachine exceeding a threshold relating to this information, an alert.

For example, the duration threshold can be a duration in days or in months. The threshold relating to the information can be a threshold based on a difference between two values. The alert can be of any type, for example an alert in service, an alert related to maintenance operations, etc.

According to one particular mode of implementation, the out-of-date state of said at least one portion of digital twins of a plurality of turbomachines among the fleet of turbomachines is determined, and said association comprises the association of a device with each turbomachine of a subgroup of said plurality of turbomachines.

Here, the plurality of turbomachines share the same need: they all have the same portion of digital twin which is not up to date.

The subgroup can comprise one or several turbomachines. It has been observed that it suffices to associate a small number of turbomachines (the subgroup) with devices if the same need is shared by several turbomachines. This also allows limiting the impact on the mass embedded by all the turbomachines of the fleet.

The person skilled in the art will know how to choose the turbomachines that must be associated among the plurality of turbomachines.

According to one particular mode of implementation, the method comprises a subsequent step of withdrawing said device among the fleet of devices of said turbomachine among the fleet of turbomachines,

As explained above, this withdrawal is facilitated by the reversible nature of the attachment.

According to one particular mode of implementation, the method further comprises a development of a digital twin from said indicator.

This step can be implemented within the digital twin storage entity.

According to one particular mode of implementation, the method further comprises a comparison processing of the indicator that allows the update of the digital twin with the digital twin.

Typically, it is possible to check whether a discrepancy is observable between the indicator that allows the update and the information already recorded in the digital twin. An additional processing can then be implemented if the discrepancy is considered too large (typically the generation of an alert).

According to one particular mode of implementation, the digital twin storage entity is embedded by the aircraft or is remote.

Indeed, the digital twin storage entity can be embedded on the turbomachine, on the aircraft (for example with a digital twin of the aircraft). It can also be remote, typically on a ground station. In this case, the communication can be done either in a wireless manner when the aircraft is on the ground, or in a wired manner when the device is withdrawn.

The invention also proposes a method for managing a fleet of turbomachines by means of devices managed according to the method as described above.

The invention also proposes an information communication device with reversible attachment on an aircraft turbomachine, comprising:

a module for attaching the device to the turbomachine,

a module for acquiring at least one turbomachine operating parameter,

a module for developing at least one indicator that allows the update of a digital twin of the turbomachine based on the operating parameter acquired,

a module for communicating said indicator that allows the update of the digital twin to a digital twin storage entity.

This device can be configured for the implementation of all the particular modes of implementation of the method as described above.

According to one particular embodiment, the device further comprises a supply (typically power supply) unit configured to be coupled to a supply (typically power supply) source.

The power supply source can be embedded and be a battery, coupled to the supply unit and allowing the operation of the device independently of the turbomachine on which it is intended to be embedded.

The autonomy of the modular device provided by the supply source allows occasionally installing the device on a turbomachine without connecting it by a cable to a supply source and thus facilitating its installation by avoiding having to pass a cable on the turbomachine between the supply source and the device.

The power supply is preferably carried out through a secure supply source such as an isolated supply for example or an autonomous energy system.

The invention also proposes a system comprising a fleet of at least one device as described above and at least one digital twin storage entity.

The invention also proposes an aircraft turbomachine equipped with a device as described above.

The invention also proposes an aircraft equipped with the turbomachine as described above.

### BRIEF DESCRIPTION OF THE DRAWINGS

Other characteristics and advantages of the present invention will become apparent from the description given below, with reference to the appended drawings which illustrate one exemplary embodiment without limitation. On the figures:

FIG. 1 schematically illustrates the steps of a method according to one example.

FIG. 2 is a schematic representation of a device on a turbomachine.

FIG. 3 illustrates an assembly with devices, turbomachines and a storage entity.

FIG. 4 is an aircraft with a turbomachine equipped with a device.

### DESCRIPTION OF THE EMBODIMENTS

A method for managing a fleet of information communication devices with reversible attachment on aircraft turbomachines will now be described.

This method for managing a fleet of devices can be implemented within the framework of a method for managing a fleet of turbomachines, particularly for turbomachines for which digital twins are stored in storage entities (typically ground stations owned by the company that manufactured the turbomachine). By way of indication, the management of a fleet of turbomachinery includes the management of the maintenance, the management of the assignment to aircrafts, etc.

As is understood, there is a need to acquire the most up-to-date turbomachine digital twins possible. The method presented below allows meeting this need, by minimizing the addition of mass on the turbomachines among the fleet of turbomachines.

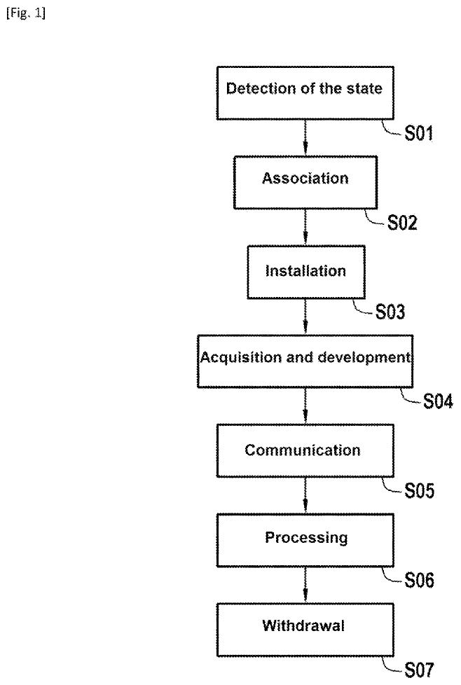

FIG. 1 represents one example of a method for managing a fleet of devices. In this method, at least one device among a fleet of devices which may be identical or different, a turbomachine among a fleet of turbomachines, and an entity for storing a digital twin of this turbomachine, are used.

In a first step S01, the out-of-date state of at least one portion of the digital twin of the turbomachine is determined, which requires an indicator that allows the (complete or partial) update of the digital twin of the turbomachine based on an operating parameter acquired directly on the turbomachine.

For example, in this first step S01, the out-of-date state of said at least one portion of the digital twin of the turbomachine is related to the detection of an event chosen from the group comprising: a duration since the last update of the portion exceeding a duration threshold, a discrepancy between information of said portion and information coming from the turbomachine exceeding a threshold relating to this information, an alert.

It can be noted that out-of-date also means that said parameter has not been acquired on the turbomachine for a too long duration (above a given threshold).

In this step, it is possible to check the up-to-date or the out-of-date state of several or all of the turbomachines among the fleet of turbomachines. If it is determined that a plurality of turbomachines have their digital twin portion which is out of date, then this plurality of turbomachines is to be analyzed with the devices.

That said, and as will appear more clearly below, analyzing all the turbomachines of the plurality of out-of-date turbomachines is not efficient in terms of mass because all of them will have to be equipped with devices.

Advantageously, a subgroup of the plurality is chosen during step S01.

Thus, in step S02, a device among the fleet of devices can be associated with each turbomachine of this subgroup. This association can be implemented by taking into account criteria of availability of the turbomachines or of the aircrafts on which the turbomachines are mounted, the availability of the devices, or other criteria. The availability of the aircrafts or of the turbomachines means that they can be immobilized where a device is to be attached.

This association step S02 can be implemented by the device itself or from a remote server,

Then, in step S03, a device chosen during step S02 is installed by attachment with a turbomachine chosen during step S02. This attachment is of the reversible type and may in particular be carried out by means of attachment clips (usable without tools). Typically, multipoint physical attachment means are used.

Indeed, the device is of the LRU (Line Replaceable Unit) type well known to the person skilled in the art and indicating that the device can be attached/withdrawn during an aircraft stopover.

In step S04, at least one turbomachine operating parameter is acquired. For example, this acquisition can be carried out by a sensor of the device. For example, this sensor can be a temperature sensor, a pressure sensor, an accelerometer, etc.

Also during step S04, a development of at least one indicator that allows the update of a digital twin of the turbomachine is implemented based on the operating parameter acquired. This development can comprise the preparation of a packet to be emitted by communication means of the device, or the implementation of a processing so that the information acquired can be directly usable to update a digital twin.

During step S05, the developed indicator that allows the update of the digital twin is communicated to the entity within which the digital twin is stored.

In a first variant, this communication aims to transmit the indicator to a remote storage entity. For example, when the aircraft is on the ground, a wireless link can be used to reach a receiver on the ground. This receiver can be a ground station in which the digital twin is stored or it can be in communication with the latter by means of a communication network such as the Internet. The communication can also be wired, when the device is withdrawn, it can communicate its information while being connected.

In a second variant, the storage entity is within the aircraft or within the turbomachine. In this case, the communication can be wired and be carried out even during a flight phase.

After the indicator has been received by the storage entity, a processing can be implemented in step S06, for example a comparison processing of the indicator that allows the update of the digital twin with the digital twin.

Typically, it can be checked in step S06 whether a discrepancy is observable between the indicator that allows the update and the information already recorded in the digital twin. An additional processing can then be implemented if the discrepancy is considered too large (typically the generation of an alert).

Also, it is possible, with the new information, to perform an update the digital twin with, in particular:
a resetting of health data,
an implementation of a diagnosis based on the information received,
a supply of a database,
an update of a health model of the turbomachine,
an additional configuration of the device.

It is then possible to generate alerts such recommendation to inspect or add another device (particularly if this other device is equipped with other sensors).

Finally, if enough turbomachine operating parameters have been acquired, it is possible to implement a withdrawal of the device. This withdrawal is facilitated by the reversible/removable nature of the attachment. By withdrawing the device, the turbomachine is lightened and the device can be used on another turbomachine.

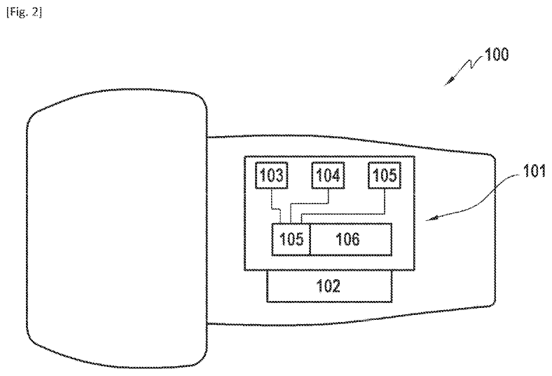

FIG. 2 represents a turbomachine 100 equipped with a device 101 such as the one used to implement the method described with reference to FIG. 1.

This device includes a module 102 for attaching the device to the turbomachine. For example, the attachment module 102 can include attachment clips with multipoint physical attachment means.

The device further includes a module 103 for acquiring a turbomachine operating parameter, typically a temperature sensor, a pressure sensor, or an accelerometer.

It also includes a module 104 for developing at least one indicator that allows the update of a digital twin of the turbomachine based on the operating parameter acquired, and a module 105 for communicating said indicator. The communication module can include an interface for wired communication (a socket), or wireless communication means.

To ensure an autonomous operation of the device, the latter includes a supply unit coupled with a battery 106.

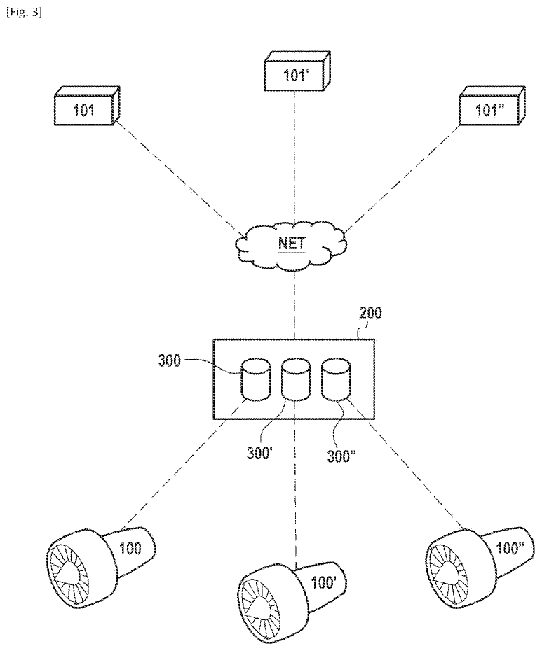

FIG. 3 illustrates a fleet of three devices 101, 101′ and 101″ similar to the device 101 described with reference to FIG. 2, and a fleet of turbomachines 100, 100′ and 100″ similar to the turbomachine 100 described with reference to FIG. 2.

The devices 100, 100′ and 100″ are in direct or indirect communication with a storage entity 200 which is here a ground station. Here, the communication between the devices and the storage entity is implemented by means of a network NET such as the internet.

In the storage entity, there are three stored digital twins 300, 300′ and 300″ respectively associated with the turbomachines 100, 100′ and 100″.

The invention is nevertheless in no way limited to the use of a single storage entity for all the digital twins. In fact, several storage entities can be used and the turbomachines can be associated with different digital twins. The devices can also be different: their module 105 can include different sensors. Thus, depending on the needs, one device will be used rather than another.

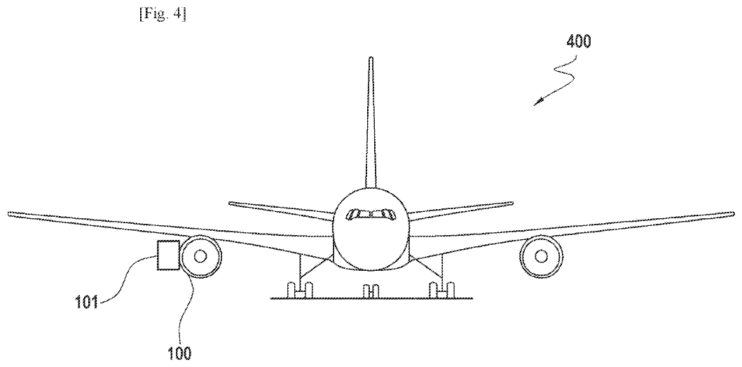

FIG. 4 shows an aircraft 400 for which a turbomachine 100 is provided with a device 101. After a flight phase, it can be envisaged to withdraw this device 100.

1. A method for managing a fleet of information communication devices with reversible attachment on aircraft turbomachines, comprising:
an association of at least one device among said fleet of devices with a turbomachine among a fleet of turbomachines,
an attachment of the device among said fleet of devices to the turbomachine among said fleet of turbomachines,
an acquisition of at least one turbomachine operating parameter,
a development of at least one indicator that allows the update of a digital twin of the turbomachine based on the operating parameter acquired,
a communication of said indicator that allows the update of the digital twin to a digital twin storage entity.

2. The method according to claim 1, comprising a preliminary step of determining the out-of-date state of at least one portion of the digital twin of the turbomachine requiring said indicator that allows the update of the digital twin of the turbomachine based on the operating parameter acquired.

3. The method according to claim 2, wherein the out-of-date state of said at least one portion of the digital twin of the turbomachine is related to the detection of an event chosen from the group comprising: a duration since the last update of the portion exceeding a duration threshold, a discrepancy between information of said portion and information coming from the turbomachine exceeding a threshold relating to this information, an alert.

4. The method according to claim 2, wherein the out-of-date state of said at least one portion of digital twins of a plurality of turbomachines among the fleet of turbomachines is determined, and said association comprises the association of a device with each turbomachine of a subgroup of said plurality of turbomachines.

5. The method according to claim 1, comprising a subsequent step of withdrawing said device among the fleet of devices of said turbomachine among the fleet of turbomachines.

6. The method according to claim 1, further comprising a development of a digital twin from said indicator.

7. The method according to claim 1, further comprising a comparison processing of the indicator that allows the update of the digital twin with the digital twin.

8. The method according to claim 1, wherein the digital twin storage entity is embedded by the aircraft or is remote.

9. A method for managing a fleet of turbomachines by means of devices managed according to the method according to claim 1.

10. An information communication device with reversible attachment on an aircraft turbomachine, comprising:
a module for attaching the device to the turbomachine,
a module for acquiring at least one turbomachine operating parameter,
a module for developing at least one indicator that allows the update of a digital twin of the turbomachine based on the operating parameter acquired,
a module for communicating said indicator that allows the update of the digital twin to a digital twin storage entity.

11. The device according to claim 10, further comprising a supply unit configured to be coupled to a supply source.

12. A system comprising a fleet of at least one device according to claim 10 and at least one digital twin storage entity.

13. An aircraft turbomachine equipped with a device according to claim 10.

14. An aircraft equipped with the turbomachine according to claim 13.
